(19) United States
(12) Patent Application Publication
(10) Pub. No.: US 2010/0185944 A1
(43) Pub. Date: Jul. 22, 2010

(54) LAYOUT APPARATUS, LAYOUT METHOD, AND STORAGE MEDIUM

(75) Inventor: Toshihiko Hosotsubo, Kamakura-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/685,584

(22) Filed: Jan. 11, 2010

(30) Foreign Application Priority Data
Jan. 16, 2009 (JP) 2009-007270

(51) Int. Cl. G06F 17/00

(52) U.S. Cl. 715/255

(57) ABSTRACT

An object deleting unit deletes one or more objects from document data containing a plurality of objects disposed on a document. An object holding unit holds each object deleted by the object deleting unit. A document data editing unit edits the document data. An area detection unit determines whether an extra area is present in the document data having been subjected to the editing processing by the document data editing unit. An object detection unit detects, among the objects held by the object holding unit, any object that can be located in the extra area of the document data detected by the area detection unit. An object layout unit relocates the object detected by the object detection unit.

### BACKGROUND OF THE INVENTION

1. Field of the Invention

The present invention relates to a layout apparatus and a layout method. To reduce the number of sheets to be used for printing a document, the layout apparatus and the layout method according to the present invention enable users to delete a document element (such as a character string or an image) from document data so that the number of pages of the document can be reduced. Further, the layout apparatus and the layout method according to the present invention enable users to restore the deleted data to the document.

2. Description of the Related Art

After the imposition for a document is completed, for example, so as to dispose two pages on each sheet having a specific size of A4, it may be determined that the number of sheets required for the document is excessive. In this case, a document element (e.g., a character string or an image) may be deleted from the document data, so that the number of imposed pages can be reduced. For example, as discussed in Japanese Patent Application Laid-Open No. 2000-227914, the deleted document element can be restored to the original document.

According to the technique discussed in Japanese Patent Application Laid-Open No. 2000-227914, a layout frame is first deleted and, as a result, the association of a document element is released from its layout position on the document. Then, the document element is registered, as a non-associated content, in a non-associated content list. Then, if the non-associated content is allocated to a new layout frame on the document, the non-associated content is deleted from the non-associated content list.

Further, the contents in the non-associated content list can be classified and managed based on information indicating a page position where the non-associated content is generated, i.e., a page position where the content was deleted.

However, according to the above-described conventional technique, it is not easy to restore the non-associated content to its original position on the document where the content was deleted. For example, a blank space of the document may be insufficient (small) compared to the size of contents to be restored. In this case, users are required to determine the contents to be restored considering relationship between the size of an available blank space of the document and the size of the contents to be restored.

To solve the above-described problems of the conventional technique, the present invention is directed to a layout apparatus and a layout method that can easily restore document contents to an appropriate position.

### SUMMARY OF THE INVENTION

According to an aspect of the present invention, a layout apparatus includes a deleting unit configured to delete at least one object from document data containing a plurality of objects disposed on a document; a holding unit configured to hold the object deleted by the deleting unit; an editing unit configured to edit the document data after the at least one object has been deleted by the deleting unit; a first detection unit configured to determine whether an extra area in which the object held by the holding unit can be located is present in the document data edited by the editing unit; a second detection unit configured to detect, among the objects held by the holding unit, any object that can be restored to the document data without increasing the number of sheets to be required to print the document data edited by the editing unit, when the presence of the extra area is confirmed by the first detection unit; and a layout unit configured to restore the object detected by the second detection unit to the document data edited by the editing unit while maintaining a positional relationship between the object detected by the second detection unit and other objects that were not deleted by the deleting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a hardware configuration of a layout apparatus according to an exemplary embodiment of the present invention.

FIG. 2 is a block diagram illustrating an example of a functional configuration of the layout apparatus according to an exemplary embodiment of the present invention.

FIG. 3 is a flowchart illustrating a procedure of object deletion processing that can be performed by the layout apparatus according to an exemplary embodiment of the present invention.

FIG. 4 illustrates an example of an initial screen that can be displayed on a display unit apparatus according to an exemplary embodiment of the present invention.

FIG. 5 illustrates an example of the screen that can be displayed on the display unit when a deletion target object is selected from document data according to an exemplary embodiment of the present invention.

FIG. 6 schematically illustrates a data format of an object that can be stored in an object holding unit.

FIG. 7 illustrates an example of the screen that can be displayed on the display unit after an object is deleted from the document according to an exemplary embodiment of the present invention.

FIG. 8 illustrates an example of the screen that indicates a state of a document display area resulting from further deletion of objects from the document according to the flowchart illustrated in FIG. 3.

FIG. 9 illustrates an example of the screen that can be displayed on the display unit when new application data is incorporated into the document according to an exemplary embodiment of the present invention.

FIG. 10 illustrates an example of the screen that can be displayed on the display unit after new application data illustrated in FIG. 9 is incorporated according to an exemplary embodiment of the present invention.

FIG. 11 is a flowchart illustrating a procedure of object relocation processing that can be performed by the layout apparatus according to an exemplary embodiment of the present invention.

FIG. 12 illustrates an example of the screen that can be displayed on the display unit when locatable objects are listed up according to an exemplary embodiment of the present invention.

FIG. 13 illustrates an example of the screen that can be displayed on the display unit when a deleted object is restored to the document according to an exemplary embodiment of the present invention.

FIG. 14 illustrates an example of the screen that can be displayed on the display unit in a case where there is any other remaining space available for the layout in the document after the processing of the flowchart illustrated in FIG. 11 is finished according to an exemplary embodiment of the present invention.

FIG. 15 illustrates an example of the screen that can be displayed on the display unit in a case where there is not any sufficient space available for the layout after the processing of the flowchart illustrated in FIG. 11 is finished, according to an exemplary embodiment of the present invention.

FIG. 16 illustrates an example of the screen that can be displayed on the display unit as a result of processing performed in step S1008 according to an exemplary embodiment of the present invention.

FIG. 17 illustrates an example of the screen that can be displayed on the display unit when the grouping of deletion objects is instructed according to an exemplary embodiment of the present invention.

FIG. 18 is a block diagram illustrating another example of the functional configuration of the layout apparatus according to an exemplary embodiment of the present invention.

FIG. 19 illustrates an example of the screen that can be displayed on the display unit after an object has been deleted from the document according to an exemplary embodiment of the present invention.

FIG. 20 is a flowchart illustrating another procedure of the object relocation processing that can be performed by the layout apparatus according to an exemplary embodiment of the present invention.

### DESCRIPTION OF THE EMBODIMENTS

Various exemplary embodiments, features, and aspects of the invention will be described in detail below with reference to the drawings.

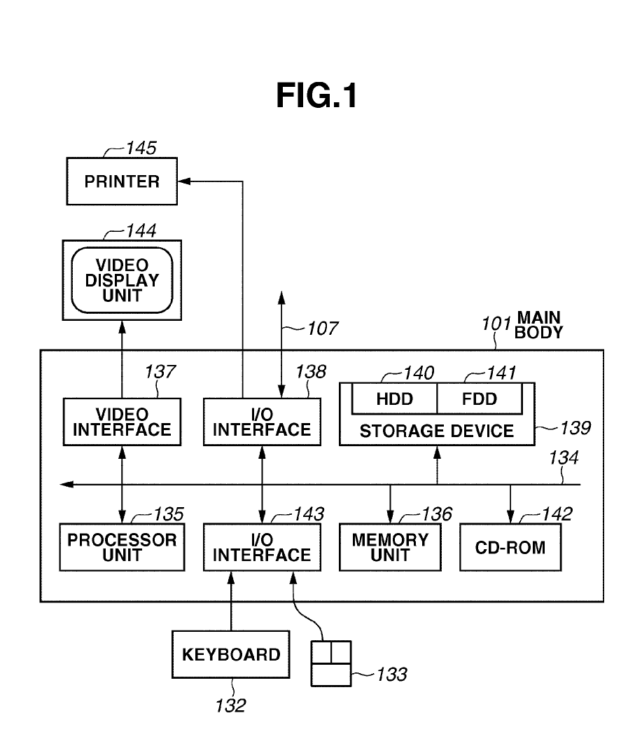

FIG. 1 is a block diagram illustrating a hardware configuration of a layout apparatus according to an exemplary embodiment of the present invention. As illustrated in FIG. 1, a main body 101 that constitutes the layout apparatus according to an exemplary embodiment of the present invention is connected via an input/output interface 143 to an input device that includes a keyboard 132 and a pointing device (e.g., a mouse 133).

The main body 101 is further connected via a video interface 137 to a video display unit 144 that can serve as an output device. The main body 101 can be further connected via an input/output interface 138 to output devices including a printer 145 according to an operation status.

The input/output interface 138 has a function of connecting the main body 101 to a network 107. For example, the main body 101 can communicate with other computer apparatus via the network 107. A typical example of the network 107 is a local area network (LAN) or a wide area network (WAN).

The main body 101 includes at least one processor unit (CPU) 135 that can control various operations to be performed by the main body 101 and a memory unit 136 that may be, for example, constituted by a semiconductor device such as a random access memory (RAM) or a read only memory (ROM).

A storage device 139 includes a hard disk drive 140 and a floppy® disk drive 141. The storage device 139 can transmit and receive data to and from a computer-readable medium that can store programs. Although not illustrated, the storage device 139 may include a magnetic tape drive. A compact disc-ROM (CD-ROM) drive 142 can serve as a nonvolatile data source.

The main body 101 may use components that perform communication via an interconnection bus 134 according to an operating system such as LINUX® or Microsoft Windows®. The main body 101 can further use the input/output interface 138 that performs communication via the interconnection bus 134, according to a method using an ordinary operation mode of a conventionally known computer system in this technique field.

In other words, respective components connected via the interconnection bus 134 can communicate with each other and may be used by an operating system installed on the main body 101 of the layout apparatus.

Software programs that can realize a layout method according to an exemplary embodiment of the present invention can be, for example, stored in a computer-readable medium such as the above-described storage device 139. The software programs can be loaded from the computer-readable medium to the main body 101. The CPU 135 of the main body 101 can execute the software programs.

In a case where a user operates the main body 101 to implement a computer program-based program, the main body 101 can be used as an apparatus that is useful to realize document layout edit processing. In the present exemplary embodiment, the CPU 135 can read and execute the software programs to realize the processing illustrated in flowcharts described below.

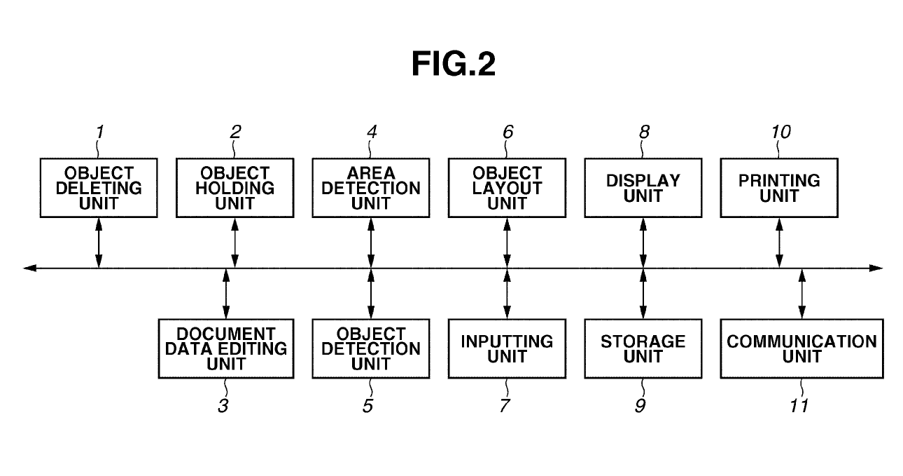

FIG. 2 is a block diagram illustrating a functional configuration of the layout apparatus according to the first exemplary embodiment. The layout apparatus according to the present exemplary embodiment includes an object deleting unit 1, an object holding unit 2, a document data editing unit 3, an area detection unit 4, an object detection unit 5, and an object layout unit 6. The layout apparatus further includes an inputting unit 7, a display unit 8, a storage unit 9, a printing unit 10, and a communication unit 11.

The object deleting unit 1 can delete one or more objects from data of a document in which a plurality of objects are disposed. The object holding unit 2 holds the object deleted by the object deleting unit 1. In this case, in addition to the deleted object, the object holding unit 2 holds positional information indicating a relationship between the deleted object and other objects positioned in the vicinity of the deleted object.

The document data editing unit 3 can edit the above-described document data. The area detection unit 4 can detect whether an extra area is present in the document data having been subjected to the editing processing. If the extra area is present, the area detection unit 4 further calculates a layout space for the extra area (i.e., a blank area where no object is disposed).

The object detection unit 5 can determine whether the object holding unit 2 stores an object that can be located in the extra area of the document data detected by the area detection unit 4. The object layout unit 6 relocates the object detected by the object detection unit 5 in the above-described document data.

In particular, the object layout unit 6 locates the object at an appropriate position of the above-described document data, referring to the above-described relationship information held by the object holding unit 2. The processor unit (CPU) 135 and the memory unit 136 illustrated in FIG. 1 can realize the above-described functions.

The inputting unit 7 can perform processing for inputting various information and commands for the layout apparatus. The input/output interface 143, the keyboard 132, and the mouse 133 illustrated in FIG. 1 can realize the inputting unit 7. The display unit 8 can display various information and data. The processor unit 135, the video interface 137, and the video display unit 144 illustrated in FIG. 1 can realize the display unit 8. The inputting unit 7 and the display unit 8 can function as a user interface.

The storage unit 9 can store various application software and data. The storage device 139 illustrated in FIG. 1 can realize the storage unit 9. The printing unit 10 can execute processing for printing an image based on the document data. The input/output interface 138 and the printer 145 illustrated in FIG. 1 can realize the printing unit 10.

The communication unit 11 can control communications to be performed between the layout apparatus and external devices. The input/output interface 138 illustrated in FIG. 1 can realize the communication unit 11.

Examples of processing that can be performed by the layout apparatus according to the first exemplary embodiment are described below. First, processing for deleting an object from document data is described below.

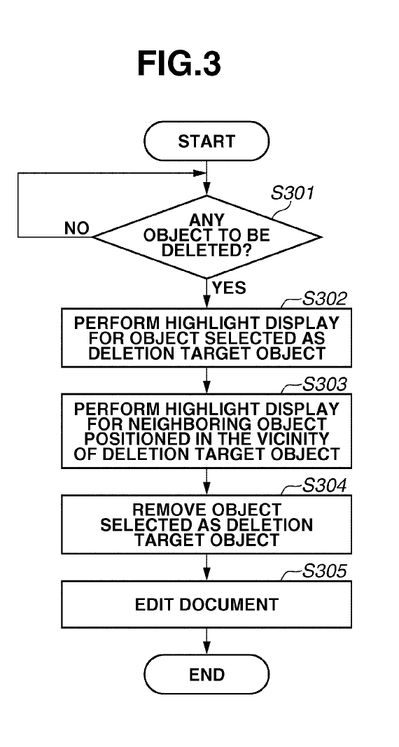

FIG. 3 is a flowchart illustrating a procedure of object deletion processing that can be performed by the layout apparatus according to the present exemplary embodiment.

In the flowchart illustrated in FIG. 3, first in step S301, the object deleting unit 1 determines whether a user has instructed to delete an object from document data. If it is determined that the user has instructed to delete at least one object from the document data (YES in step S301), the processing proceeds to step S302. On the other hand, if it is determined that the user has not instructed to delete any object from the document data (NO in step S301), the processing returns to step S301.

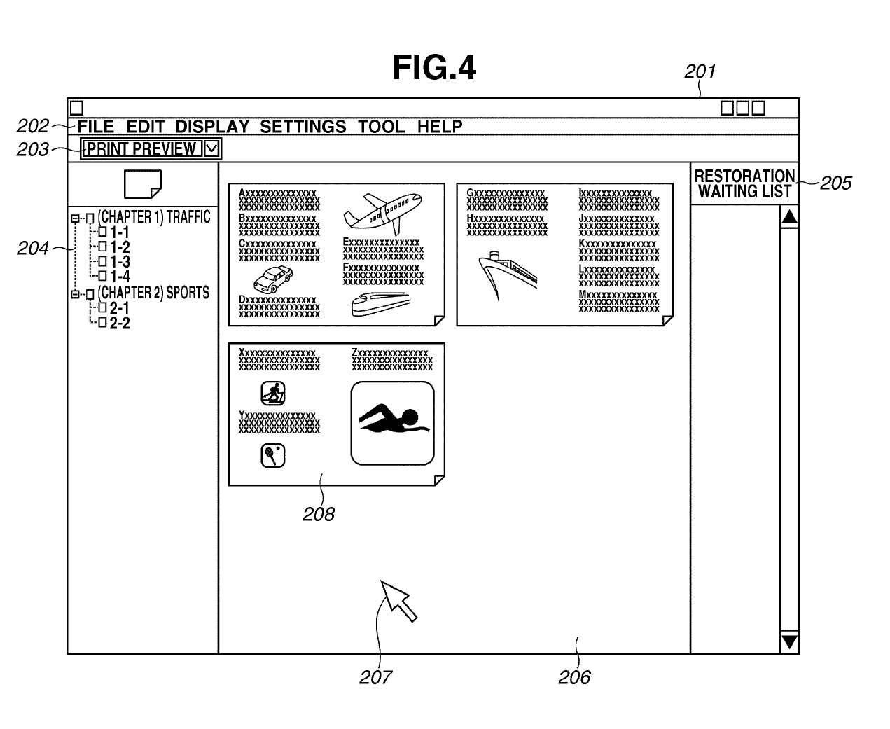

FIG. 4 illustrates an example of an initial screen 201 that can be displayed by the display unit 8. The screen 201 includes a menu 202 that can be operated to execute various commands (e.g., opening a document file) and a display mode selection list box 203 that can be used to select a document display mode. The screen 201 further includes a document display area 206 that can display a document 208.

In the present exemplary embodiment, each “document” includes one or more “chapters.” Each “chapter” can be generated for each file incorporated in a document. A chapter name can be allocated to each chapter. Each chapter includes one or more “pages.” Each “page” corresponds to one page of application data of a file incorporated in a document. A tree view 204 can display a hierarchical (i.e., “document”—“chapter”—“page”) configuration.

The document 208 includes two chapters. The first chapter is composed of four pages. The second chapter is composed of two pages. In other words, the document 208 includes a total of six pages. Further, each set of two pages of the document 208 can be disposed on a single printing sheet. In other words, the above-described six pages are disposed on three sheets.

A restoration waiting list 205 can display an icon of each deleted object. A mouse pointer 207 can be operated by a use, for example, to press a button or select an object. In this case, the user can operate the inputting unit 7 (e.g., the mouse) to move the mouse pointer 207.

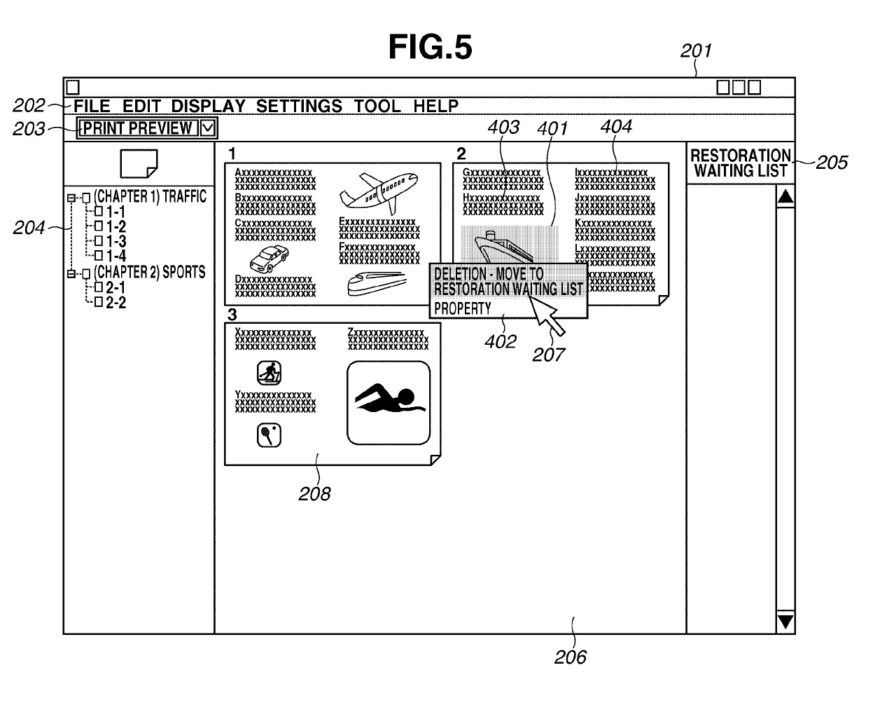

FIG. 5 illustrates an example of the screen 201 that can be displayed on the display unit 8 when an object to be deleted is selected from the document data. If the user selects an object (e.g., a text block or an image block) in the document through the processing performed by the inputting unit 7, a deletion target object 401 is highlight displayed. Then, if the user right-clicks the mouse in this state, a context menu 402 can be displayed. If the user selects an item instructing deletion of an object (i.e., a data block) on the context menu 402, selection of a deletion target object 401 can be completed.

Referring back to FIG. 3, if it is determined that the user has instructed to delete an object from the document data (YES in step S301), then in step 5302, the display unit 8 performs a highlight display for the deletion target object 401 (i.e., the object to be deleted). Subsequently, in step S303, the display unit 8 performs a highlight display for neighboring objects positioned in the vicinity of the deletion target object 401 (i.e., the object to be deleted).

For example, according to the example illustrated in FIG. 5, an object 403 positioned before the deletion target object 401 and an object 404 positioned after the deletion target object 401 are neighboring objects positioned in the vicinity of the deletion target object 401 (i.e., the object to be deleted.

Next, instep S304, the object deleting unit 1 removes the deletion target object 401 (i.e., the object to be deleted) from the document 208. In the present exemplary embodiment, the deletion target object can be stored in the object holding unit 2 together with information indicating a positional relationship (i.e., relative positional information) between the deletion target object and the neighboring objects positioned in the vicinity of the deletion target object.

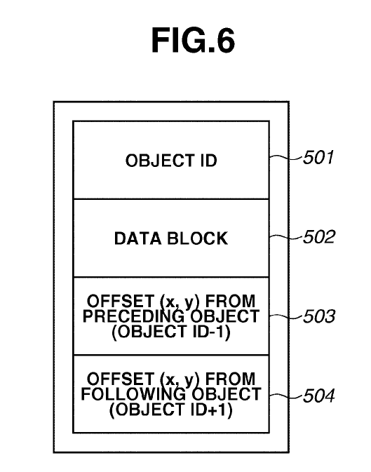

FIG. 6 schematically illustrates an example of a data format of an object stored in the object holding unit 2. An object ID 501 represents identification (ID) of the selection object (i.e., the object to be deleted). The object ID 501 can be set as unique information. The object deleting unit 1 can determine the object ID 501 when the object ID 501 is stored in the object holding unit 2. A data block 502 represents data of the object deleted from the document 208.

A first offset value 503 indicates an offset (x, y) from an object having a preceding ID (i.e., object ID−1) that precedes the object stored in the object holding unit 2 (i.e., the deleted object 401). The object deleting unit 1 can calculate the first offset value 503 in the following manner, in a coordinate system defined by the y axis representing the vertical direction (i.e., the direction of the final page in a case where page printing areas are vertically connected) and the x axis representing the horizontal direction, wherein the upper left corner of a printing area of the first page of the document 208 is designated as a reference point.

The object deleting unit 1 can determine a coordinate point indicating the upper left corner of the object identified by the “object ID” by adding the offset value to a coordinate point indicating the upper left corner of the preceding object identified by the “object ID−1.” In a case where there is not any object having the preceding ID (object ID−1), namely, when the target object is an object having the first ID in the document 208, an offset value from a reference point indicating the upper left corner of a sheet constituting the first page of the document 208 can be set.

A second offset value 504 indicates an offset (x, y) from the object having a subsequent ID (i.e., object ID+1) that follows the object (i.e., the deleted object 401) stored in the object holding unit 2. The object deleting unit 1 can determine the coordinate point indicating the upper left corner of the object identified by the “object ID” by subtracting the offset value from a coordinate point indicating the upper left corner of the subsequent object identified by the “object ID+1.”

Referring back to FIG. 3 again, in step S305, the document data editing unit 3 edits the document 208. The editing processing performed by the document data editing unit 3 in this case is processing for changing the layout of the document data after the deletion target object is removed. More specifically, so as to eliminate a blank corresponding to an object size at the position where the deleted object was present, all objects that follow the deleted object are shifted toward the first page (i.e., −y direction in the above-described coordinate system).

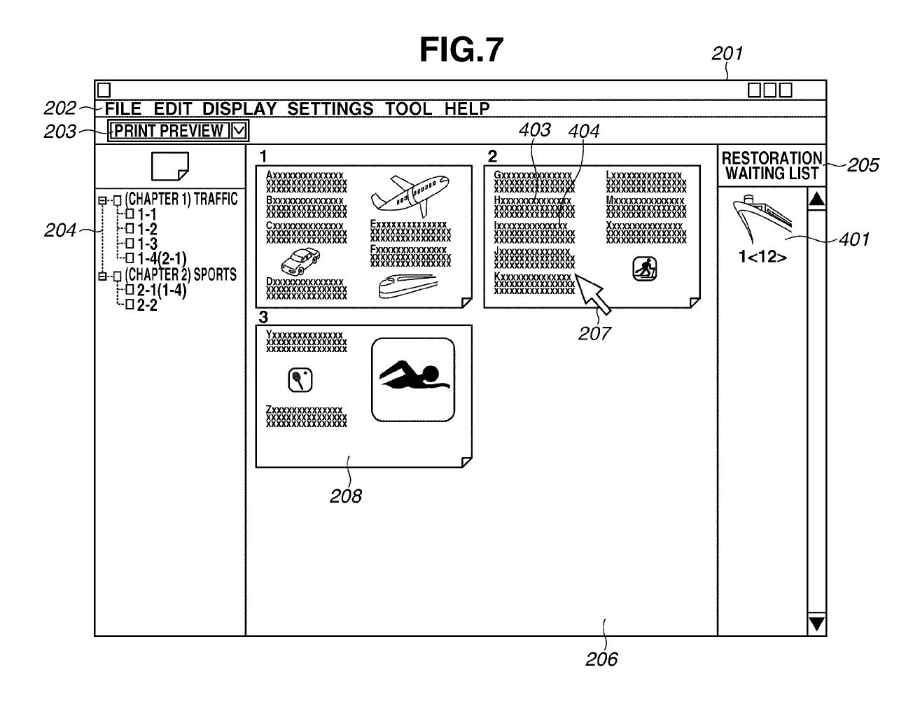

FIG. 7 illustrates an example of the screen 201 that can be displayed on the display unit 8 after the object 401 has been deleted from the document. In a state illustrated in FIG. 7, an icon representing the deleted object 401 is present in the restoration waiting list 205. An object group including the object 404 and subsequent objects, which was positioned behind the deleted object 401, is located at a forward position so as to eliminate the blank generated when the object 401 is deleted.

In the present exemplary embodiment, the data representing the deleted object can be registered together with data representing the blank existing between the deleted object and the following object. Alternatively, the data representing the blank existing between the deleted object and the following object may be selected as a deletion target and may be registered (i.e., blank contents).

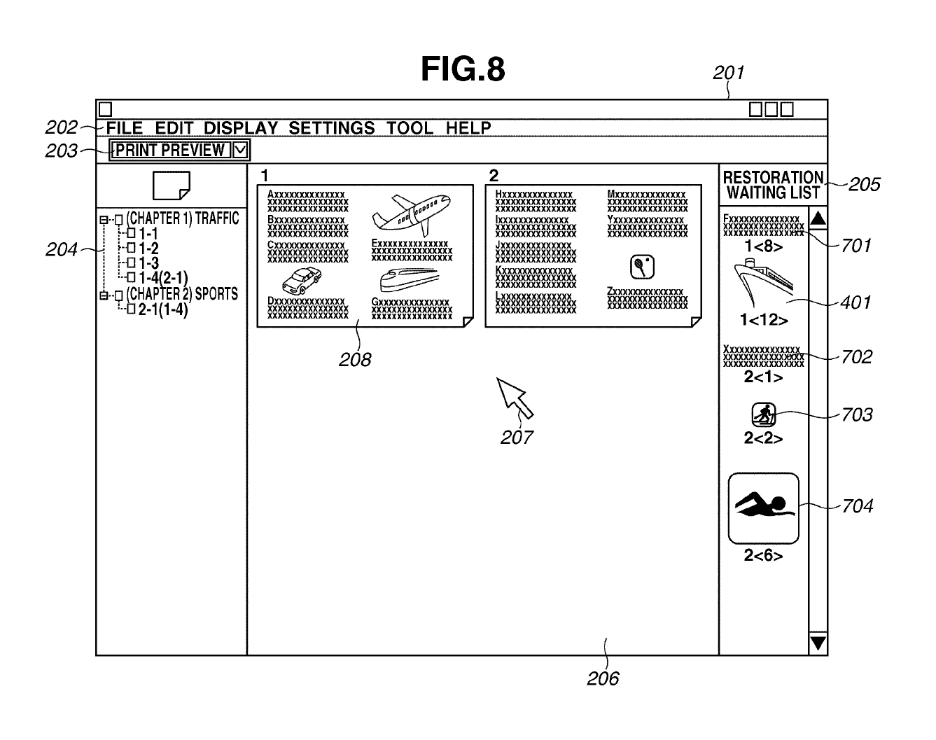

FIG. 8 illustrates an example of the screen 201 that indicates a state of the document display area 206 resulting from further deletion of objects from the document 208 according to the flowchart illustrated in FIG. 3. According to the example illustrated in FIG. 8, as a result of deletion of a plurality of objects, one complete sheet required for the printing of the document 208 is eliminated.

At this moment, the document 208 is composed of a total of four pages, which are imposed on two sheets. The restoration waiting list 205 stores new objects 701 to 704 registered as deletion object data.

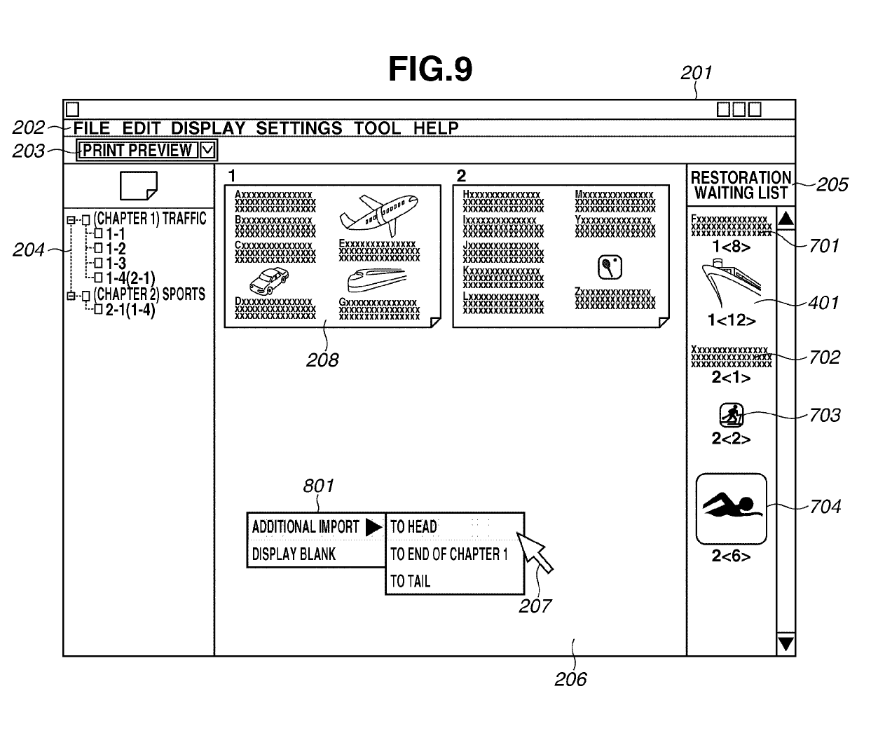

FIG. 9 illustrates an example of the screen 201 that can be displayed on the display unit 8 when new application data is incorporated into the document 208. In this case, a context menu 801 can be displayed by right clicking the mouse that constitutes the inputting unit 7. The context menu 801 enables users to select desired data from files stored in the storage unit 9, as the application data to be incorporated to the document 208.

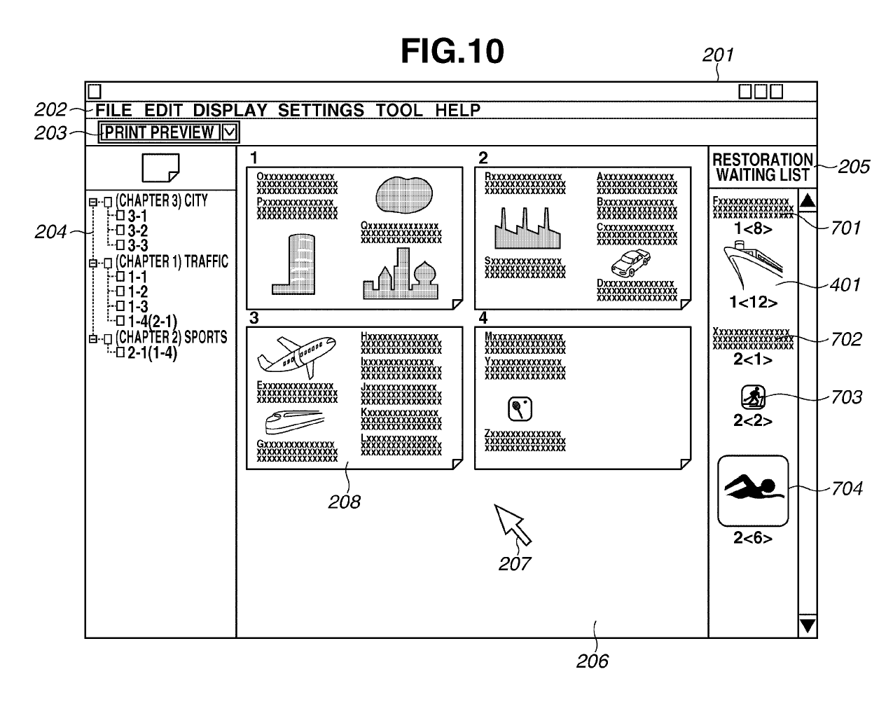

FIG. 10 illustrates an example of the screen 201 that is displayed on the display unit 8 after the new application data illustrated in FIG. 9 is incorporated. At this moment, the document 208 includes a total of three chapters composed of seven pages, which are imposed on four sheets.

In other words, as a result of incorporation of the new application data, two sheets are newly added as sheets required for the printing. Further, it is understood that the right page of the fourth printing sheet is an empty page where no object is present and a new object can be allocated.

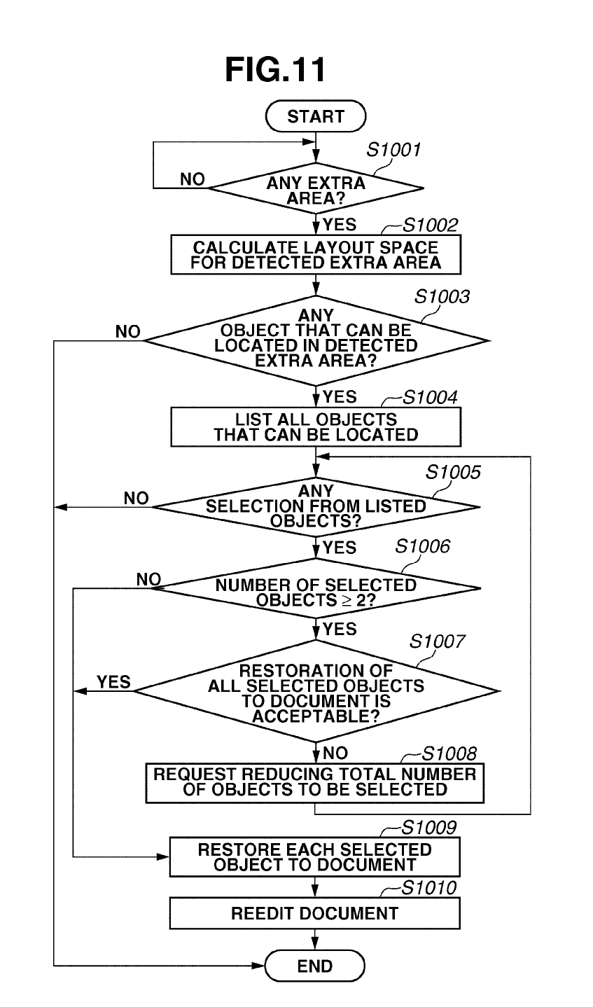

Next, an example of processing for relocating a once deleted object on the document data is described below. FIG. 11 is a flowchart illustrating a procedure of object relocation processing that can be performed by the layout apparatus according to the present exemplary embodiment.

First, in step S1001 of the flowchart illustrated in FIG. 11, the area detection unit 4 determines whether an extra area is present in the document data. The area detection unit 4 executes the processing of step S1001 in a case where the number of pages constituting the document is increased. If it is determined that no extra area is present in the document data (NO in step S1001), the area detection unit 4 repeats the above-described determination processing.

On the other hand, if it is determined that an extra area is present in the document data (YES in step S1001), then in step S1002, the area detection unit 4 calculates a layout space (i.e., a blank area) for the detected extra area. In the present exemplary embodiment, the area detection unit 4 calculates an empty layout space that extends in the vertical direction, i.e., the y-axis direction of the above-described coordinate system. In the present exemplary embodiment, the empty layout space is a blank area in which a rectangular shape having a width comparable to a page width can be located.

Next, in step S1003, the object detection unit 5 determines whether the object holding unit 2 stores any object that can be located in the extra area detected by the area detection unit 4. If it is determined that there is not any object that can be located in the above-described extra area (NO in step S1003), the processor unit 135 terminates the processing of the routine illustrated in FIG. 11.

On the other hand, if it is determined that there is an object that can be located in the above-described extra area (YES in step S1003), then in step S1004, the display unit 8 selects each object that can be located. In a case where there are two or more objects that can be located, the display unit 8 selects all of the objects that can be located.

Icons of all objects stored in the object holding unit 2 are displayed in the restoration waiting list 205 of the screen 201. Accordingly, in step S1004, the display unit 8 performs a highlight display for each icon of the object that can be located in the above-described extra area as a listing operation.

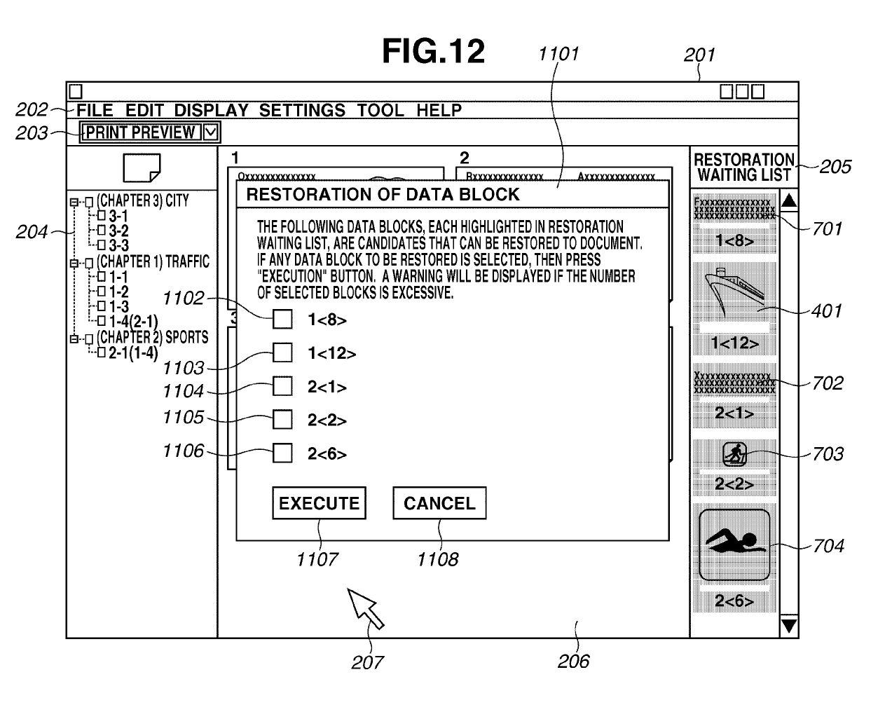

FIG. 12 illustrates an example of the screen 201 that can be displayed on the display unit 8 after a plurality of objects that can be located are listed. According to the result of the determination made by the object detection unit 5 as illustrated in FIG. 12, all of the registered objects are candidates that can be restored to the document 208.

More specifically, the objects 401 and 701 to 704 registered in the restoration waiting list 205 can be moved to the extra area of the document 208. Therefore, the display unit 8 performs a highlight display for all of these registered objects 401 and 701 to 704 in the restoration waiting list 205 to indicate that these objects can be restored to the document 208.

A data block restoration dialog 1101 is a dialog that enables users to select an object (or objects) and instruct restoring the selected object (or objects) to the document 208. Check boxes 1102 to 1106 enable users to select objects to be restored to the document 208. An execution button 1107 can be operated to instruct restoring respective objects selected via the check boxes 1102 to 1106 to the document 208. A cancel button 1108 can be operated to instruct restoring no object to the document 208.

Referring back to FIG. 11, in step S1005, the object layout unit 6 determines whether the user has selected at least one of the listed objects. If it is determined that there is not any listed object that is selected by the user (NO in step S1005), the processor unit 135 terminates the processing of the routine illustrated in FIG. 11. More specifically, the user presses the cancel button 1108 on the data block restoration dialog 1101 illustrated in FIG. 12.

On the other hand, if it is determined that the listed object is selected (YES in step S1005), then in step S1006, the object layout unit 6 determines whether two or more objects have been selected. More specifically, when the user presses the execution button 1107 on the data block restoration dialog 1101, the object layout unit 6 determines whether the user has selected two or more data via the check boxes 1102 to 1106 on the data block restoration dialog 1101.

If there is only one object selected in step S1006 (NO in step S1006), then in step S1009, the object layout unit 6 restores the listed object to the document 208.

In the present exemplary embodiment, the object layout unit 6 restores the object to the document 208 based on ID information of the preceding and following objects (i.e., the object that precedes the deleted object and the object that follows the deleted object) and positional information of the deletion target object relative to the preceding and following objects, which are stored in the object holding unit 2. More specifically, when the object layout unit 6 restores the object 401 to the document 208, the object layout unit 6 searches the object 403 having the object ID “ID−1” in the document 208 based on the object ID 501 of the object 401.

The object layout unit 6 determines a coordinate point of the upper left corner of a space in which the object 401 can be located based on the data representing the offset (x, y) from the preceding object 403 having the object ID “ID−1.” The object layout unit 6 locates the data block 502 of the object 401 to the position identified by the coordinate point of the determined upper left corner.

However, in a case where the object having the object ID “ID−1” is not present in the document 208, the object layout unit 6 searches an object having an object ID “ID−2”. If the object layout unit 6 cannot find any object positioned closest in the −y direction of the above-described coordinate system from the document 208, in the deleting processing, the object layout unit 6 uses the reference point of the above-described coordinate system as a coordinate point representing the upper left corner of the object having the object ID “ID−1.”

Then, in step S1010, the document data editing unit 3 performs reediting processing on the document 208. In the present exemplary embodiment, the document data editing unit 3 locates the object group disposed behind the preceding object 403 having the object ID “ID−1”, i.e., positioned in the +y direction of the above-described coordinate system, to the position following the object 401.

In this case, the document data editing unit 3 determines a coordinate point of the upper left corner of the leading object 404 of the object group based on the data representing the offset (x, y) (the second offset value 504) from the subsequent object 404 having the object ID “ID+1.”

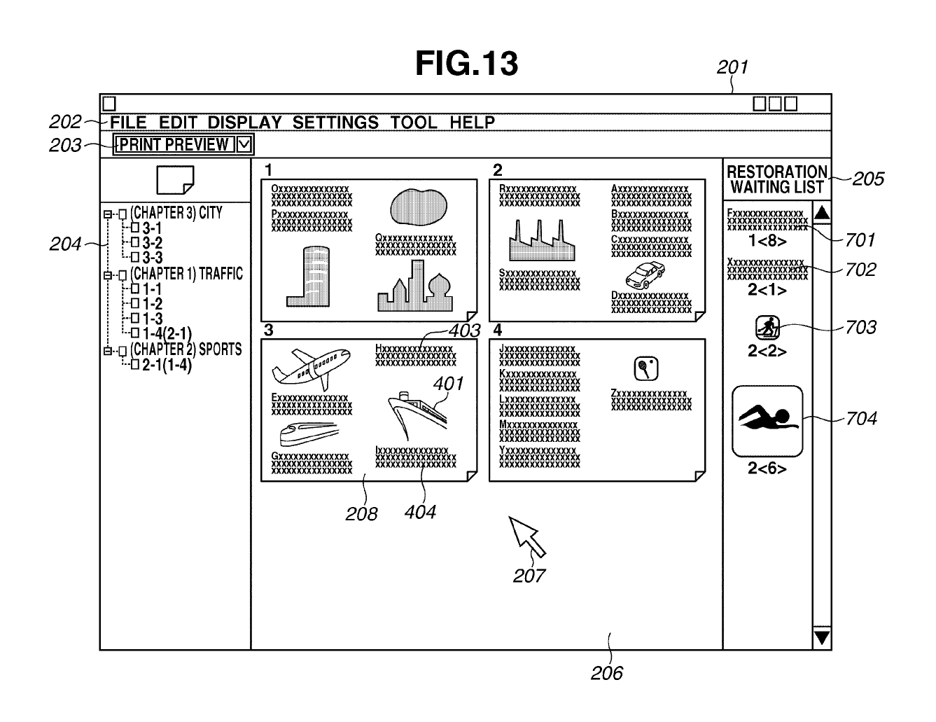

FIG. 13 illustrates an example of the screen 201 that is displayed on the display unit 8 when the deleted object 401 is restored to the document 208. As understood from FIG. 13, the page on which the object 401 is newly located is different from the former page on which the object 401 was located. However, there is not any change in the positional relationship between the object 401 and two objects 403 and 404. Namely, the restored object 401 is located between the preceding object 403 and the subsequent object 404.

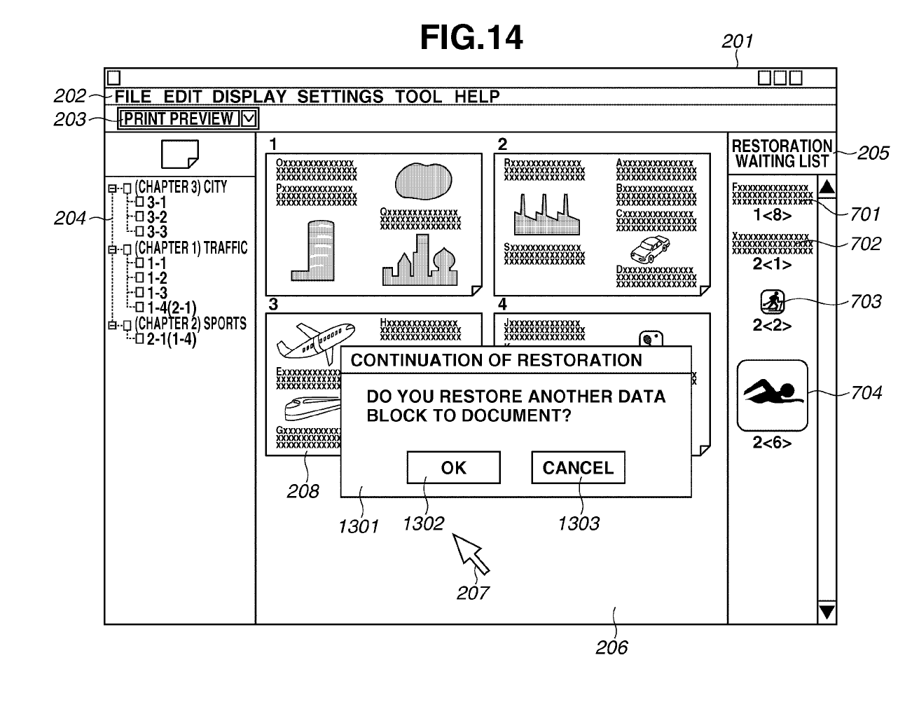

FIG. 14 illustrates an example of the screen 201 that is displayed on the display unit 8 in a case where there is any other remaining space available for the layout in the document 208 after the processing of the flowchart illustrated in FIG. 11 is finished.

If the area detection unit 4 detects any remaining space available for the layout in the document 208, the display unit 8 displays a “continuation of restoration” dialog 1301. The “continuation of restoration” dialog 1301 includes an “OK” button 1302 that can be pressed to instruct continuing the restoration and a “cancel” button 1303 that can be pressed to cancel the continuation of the restoration. If the “OK” button 1302 is pressed while the “continuation of restoration” dialog 1301 is displayed, the processing of the flowchart illustrated in FIG. 11 is newly executed.

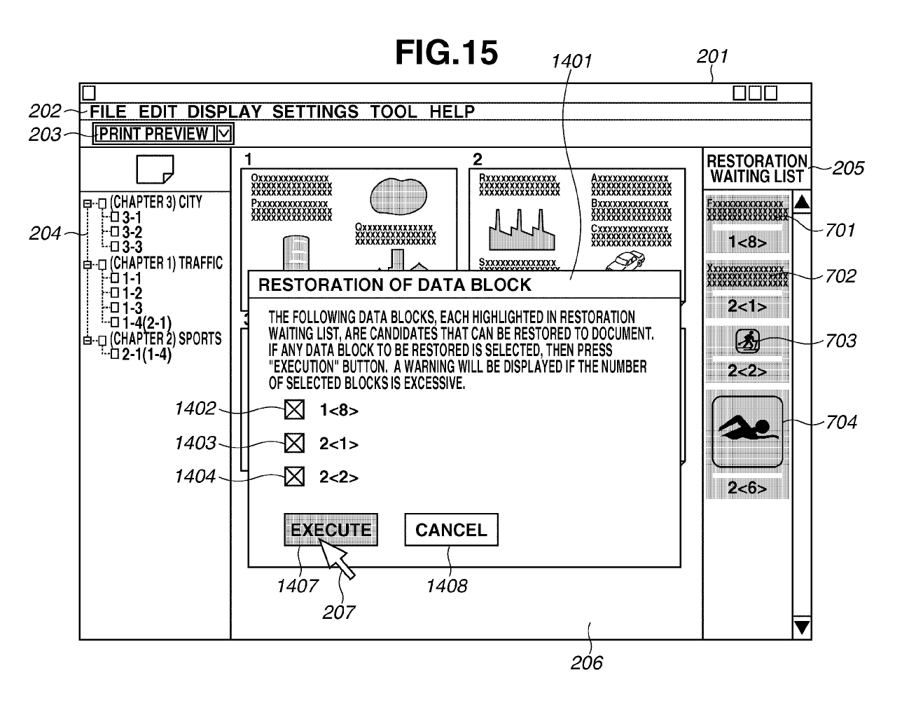

On the other hand, FIG. 15 illustrates an example of the screen 201 that is displayed on the display unit 8 in a case where there is not any sufficient space available for the layout in the document 208 after the processing of the flowchart illustrated in FIG. 11 is finished.

For example, if the area detection unit 4 determines that an extra area (i.e., the empty layout space) into which all of the objects registered in the restoration waiting list 205 can be restored is not present in the document 208, the display unit 8 does not perform a highlight display for all objects registered in the restoration waiting list 205. In this case, the display unit 8 performs a highlight display for the objects 701, 702, and 703. In other words, the highlight display performed in this case indicates that all objects registered in the restoration waiting list 205 except for the object 704 can be restored to the document 208.

In such a case, the display unit 8 displays a “restoration of data block” dialog 1401 that does not include a check box to be prepared for the restoration of the object 704. More specifically, the “restoration of data block” dialog 1401 illustrated in FIG. 15 includes check boxes 1402 to 1404 that enable users to select all or at least part of the restoration waiting objects 701 to 703 as the objects to be restored to the document 208. If an execution button 1407 is pressed while the “restoration of data block” dialog 1401 illustrated in FIG. 15 is displayed, the object layout unit 6 accepts an instruction for restoring the restoration waiting objects 701 to 703 to the document 208.

Referring back to the flowchart illustrated in FIG. 11, if it is determined that two or more objects have been selected (YES in step S1006), then in step S1007, the object layout unit 6 determines whether all of the selected objects can be restored to the document 208. The object layout unit 6 executes the processing of step S1007 based on the calculation result in step S1002.

If it is determined that all of the selected objects can be restored to the document 208 (YES in S1007), the processing proceeds to step S1009. The processing to be performed in step S1009 and the subsequent steps is already described above.

On the other hand, if it is determined that all of the selected objects cannot be restored to the document 208 (NO in S1007), then in step S1008, the display unit 8 displays a message requesting the user to reduce the number of objects to be selected. Then, the processing proceeds to step S1005.

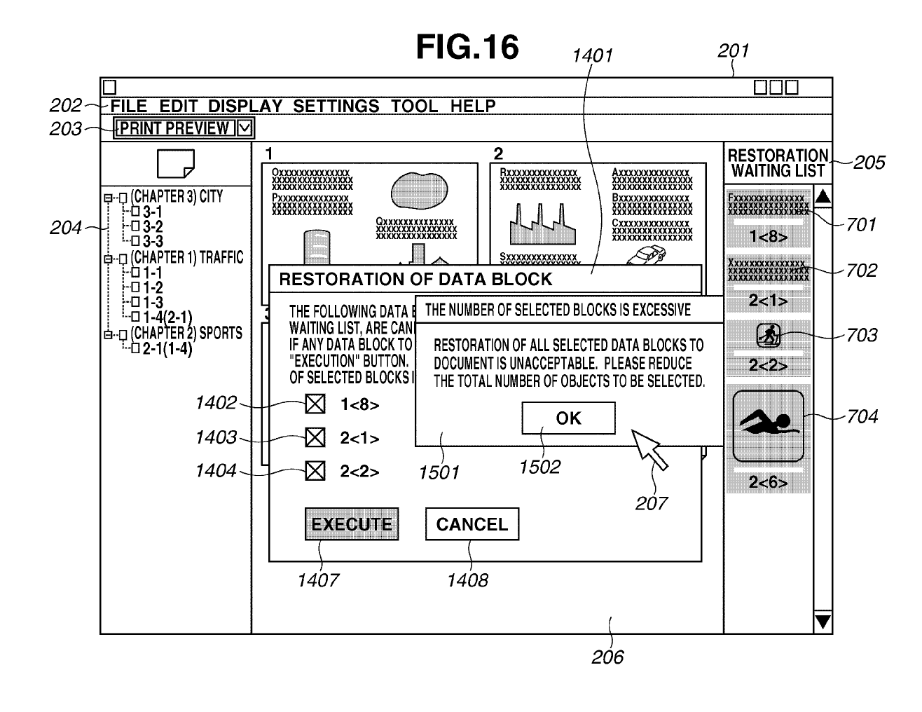

FIG. 16 illustrates an example of the screen 201 that is displayed on the display unit 8 as a result of the processing performed in step S1008. The screen 201 illustrated in FIG. 16 includes a “number of selected blocks is excessive” dialog 1501 displayed in response to the processing in step S1008. The “number of selected blocks is excessive” dialog 1501 includes an “OK” button 1502. If the “OK” button 1502 is pressed, the display unit 8 displays the “restoration of data block” dialog 1401 (see FIG. 15) to instruct the use to reselect objects to be restored.

An example grouping of the restoration waiting objects is described below. In a case where a single object is restored to a document, the restored object may become meaningless depending on the contents of the document. Hence, for the purpose of avoiding such a problem, the present exemplary embodiment performs the following grouping processing to integrate a plurality of objects that are relevant to each other.

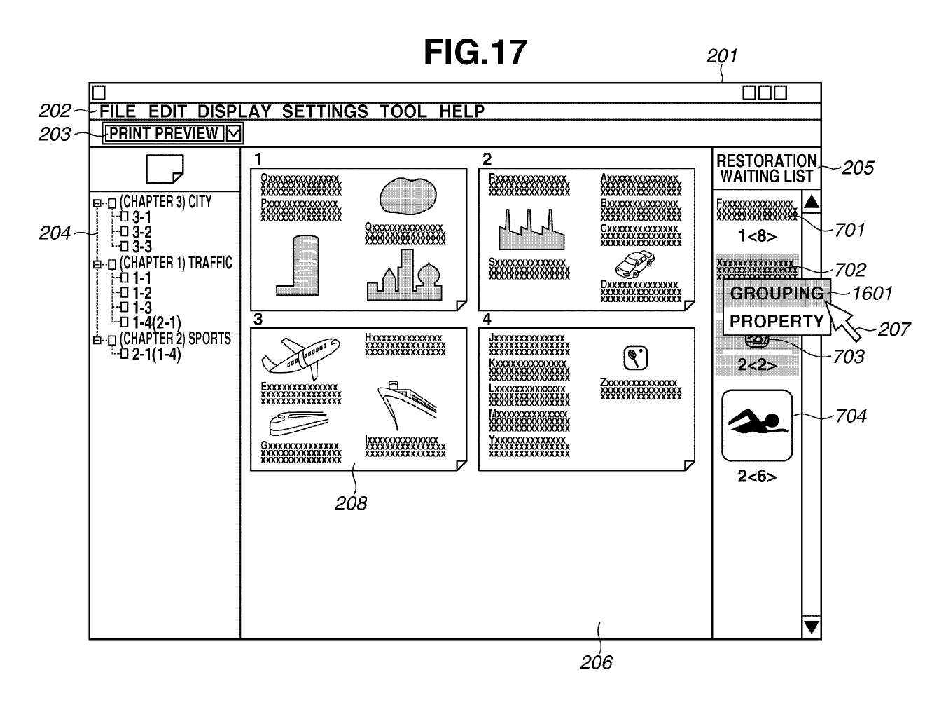

FIG. 17 illustrates an example of the screen 201 that is displayed on the display unit 8 when the grouping of deletion objects is instructed.

When the user operates the mouse or the keyboard that constitutes the inputting unit 7 in the restoration waiting list 205 to select one or more objects in the restoration waiting list 205, a context menu 1601 can be displayed by right-clicking the mouse in this state.

If the user selects the grouping while the context menu 1601 is displayed, for example, the object detection unit 5 performs the grouping of the selected one or more restoration waiting objects for a predetermined item. It is desired that the object detection unit 5 performs the above-described grouping processing together with, for example, the processing performed in step S1004 of the flowchart illustrated in FIG. 11. In this case, a plurality of restoration waiting objects integrated into the restoration waiting object group can be processed as a single restoration waiting object in step S1006 in the flowchart illustrated in FIG. 11.

Further, prior to the processing to be performed in steps S1009 to S1010 of the flowchart illustrated in FIG. 11, the object layout unit 6 releases the grouping to separate restoration waiting objects as a processing target to be subjected to the processing in step S1009 and step S1010. In this manner, employing the above-described grouping processing is useful to easily restore a plurality of restoration waiting objects that are relevant to each other.

According to the above-described processing illustrated in FIG. 11, when a new layout space is detected in step S1001, new application data can be incorporated in the document illustrated in FIG. 9. However, the present invention is not limited to the above-described case.

As another example, a new layout space can be obtained when print settings are changed. For example, in a case where a document is composed of six pages and two pages are imposed on each printing sheet, if the print settings are changed to perform two-sided printing, two more pages are available for the imposition. In this case, a new layout space for two pages can be obtained.

According to the above-described conventional technique, each non-associated content can be classified based on information indicating the page position at the time when the layout frame in which the non-associated content was ever allocated is deleted. Therefore, each non-associated content can be prioritized as a candidate to be selected in performing the document editing of the corresponding page. However, the problem is that the information relating to the original layout frame cannot be used any more.

Accordingly, users are required to relocate a layout frame relying on their own memories to restore the non-associated content to the document so as to reconstruct a positional relationship between the non-associated content and the contents that precede and follow the non-associated content when the non-associated content was deleted. Further, in a case where the contents that precede and follow the non-associated content when the non-associated content was deleted are allocated to two different pages, the non-associated content cannot be restored to the document so as to reconstruct the relationship between the original deleting position on the document and the contents that precede and follow the non-associated content when the non-associated content was deleted relying on the information relating to the page position when the non-associated content was deleted.

On the other hand, the present exemplary embodiment can store the preceding and following contents when contents of the document data are deleted. The present exemplary embodiment can restore the deleted contents again to the original position on the document where the preceding and following contents are present. Accordingly, the present exemplary embodiment can reconstruct the document so as to have meaningful contents when the once-deleted contents are restored, even in a case where the document layout is changed in a wide range including two or more pages.

According to the above-described first exemplary embodiment, when a new layout space is present in a document, objects that can be restored to the document are listed in the restoration waiting list and a selected object is restored to the document. However, there may be a specific restoration waiting object that is to be immediately restored to the document when a new layout space is detected. In such a case, a user is required to remember the presence of the specific restoration waiting object until the specific restoration waiting object is listed upon detection of a new layout space.

Hence, a layout apparatus according to a second exemplary embodiment performs restoration of each object based on a priority level allocated to this object without requiring any direct operation by the user.

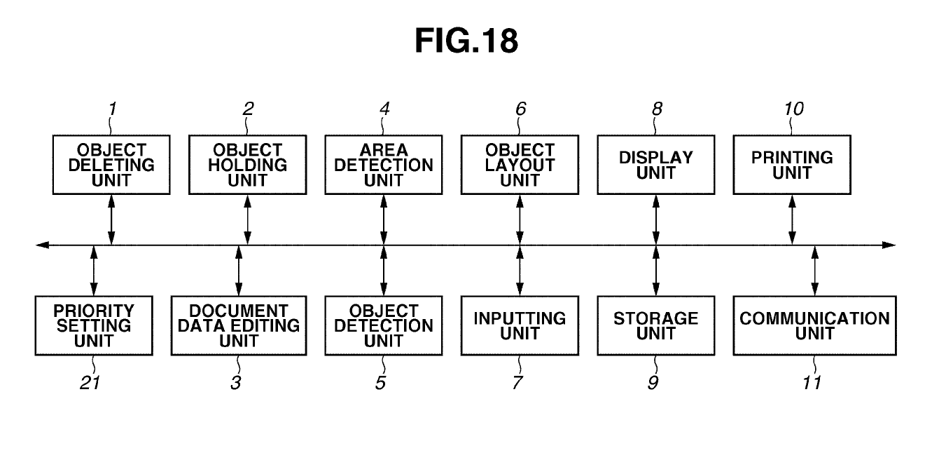

FIG. 18 is a block diagram illustrating a functional configuration of the layout apparatus according to the second exemplary embodiment. The layout apparatus according to the present exemplary embodiment includes a priority setting unit 21 in addition to the above-described functional configuration of the layout apparatus according to the first exemplary embodiment.

The priority setting unit 21 can set a priority level for each deleted object according to the order of deletion by the object deleting unit 1. Each object, if a priority level is set, can be stored in the object holding unit 2 in a manner reflecting its priority. The object detection unit 5 can detect each object stored in the object holding unit 2 referring to the priority allocated to each object.

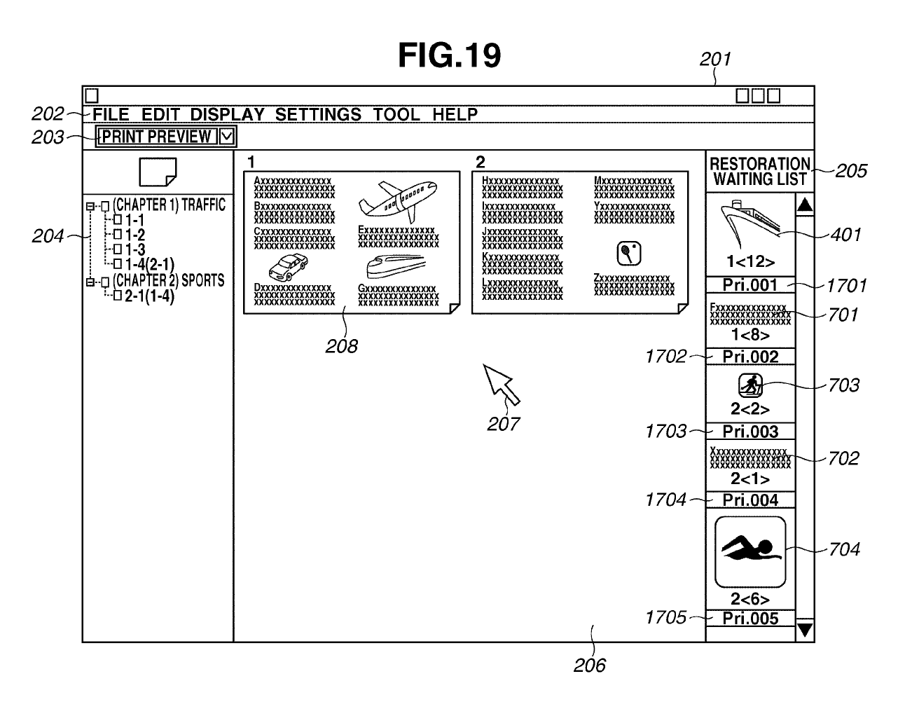

FIG. 19 illustrates an example of the screen 201 that is displayed on the display unit 8 after the object 401 has been deleted from the document. The icons of the objects displayed in the restoration waiting list 205 are arrayed in the manner reflecting their priority levels.

According to the example illustrated in FIG. 19, the order of five objects 401, 701, 703, 702, and 704 that are sequentially arrayed in the up-and-down direction reflects their priority levels. In the present exemplary embodiment, priority labels 1701 to 1705 are allocated to respective icons of the objects 401, 701, 703, 702, and 704. The priority labels 1701 to 1705 represent the priority levels of the objects 401, 701, 703, 702, and 704, respectively. If a numerical value contained in a priority label is small, the priority level is high.

The priority level of each object can be changed by operating the mouse that constitutes the inputting unit 7 to drag and drop an icon of each object displayed in the restoration waiting list 205. For example, according to the example illustrated in FIG. 19, the object 701 has the second highest priority level (Pri.002). If a user wants to give the first priority to the object 701, the user can operate the mouse to drag and drop the icon of the object 701 to a position higher than the icon of the object 401.

In this case, in response to the user's operation, the priority setting unit 21 sets the highest priority level to the object 701 and set the second highest priority level to the object 401. Similarly, if the user wants to change the priority for the object 701 from the second level to the fourth level, the user can drag and drop the icon of the object 701 to a position immediately below the icon of the object 702.

In response to such an operation by the user, the priority setting unit 21 resets the priority levels of respective objects to array them in the order of the object 401→the object 703→the object 702→the object 701→the object 704.

As described previously in the first exemplary embodiment, in a case where two or more deleted objects are integrated as a group, the priority of this group can be represented by the priority level of an object that has the highest priority in the group.

An example of main processing that can be performed by the layout apparatus according to the second exemplary embodiment is described below. The processing for deleting each object from the document data is similar to the procedure described in the first exemplary embodiment, except that a priority level is set for each object according to the deletion order. Therefore, its description is not repeated.

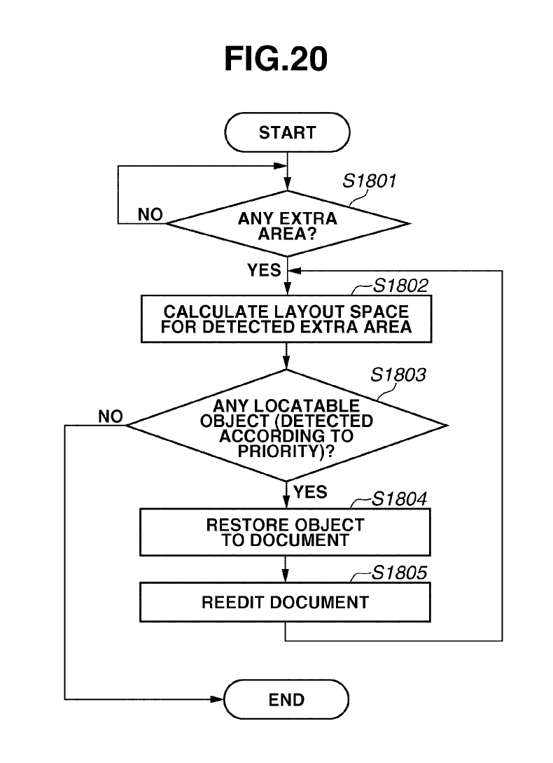

An example of processing for relocating a deleted object to document data is described below according to the present exemplary embodiment. FIG. 20 is a flowchart illustrating a procedure of the object relocation processing that can be performed by the layout apparatus according to the present exemplary embodiment.

In the flowchart illustrated in FIG. 20, in step S1801, the area detection unit 4 determines whether an extra area is present in the document data. The area detection unit 4 executes the processing of step S1801 in a case where the number of pages constituting the document is increased. If it is determined that no extra area is present in the document data (NO in step S1801), the area detection unit 4 repeats the above-described determination processing.

On the other hand, if it is determined that an extra area is present in the document data (YES in step S1801), then in step S1802, the area detection unit 4 calculates a layout space for the detected extra area. In the present exemplary embodiment, the area detection unit 4 calculates an empty layout space that extends in the y-axis direction of the above-described coordinate system. In the present exemplary embodiment, the empty layout space is a blank area in which a rectangular shape having a width comparable to a page width can be located.

Next, in step S1803, the object detection unit 5 determines whether the object holding unit 2 stores any object that can be located in the extra area detected by the area detection unit 4 based on the priority level of each object. In the present exemplary embodiment, if it is determined that there is not any object that can be located in the above-described extra area (NO in step S1803), the processor unit 135 terminates the processing of the routine illustrated in FIG. 20.

On the other hand, if it is determined that there is an object that can be located in the above-described extra area (YES in step S1803), then in step S1804, the object layout unit 6 restores the object to the document 208. Then, in step S1805, the document data editing unit 3 reedits the document 208.

Details of the processing to be performed in steps S1804 and S1805 are similar to the above-described processing in steps S1009 and S1010 illustrated in FIG. 11.

As described above, according to the present exemplary embodiment, a priority level is set for each object registered in the restoration waiting list and relocation of each object is performed based on the priority allocated to each object. Therefore, the present exemplary embodiment can relocate a plurality of objects in a manner reflecting their priority levels. In other words, the present exemplary embodiment does not require users to select objects to be relocated in the object relocation processing.

As described above, the present exemplary embodiment can determine whether the document data includes any area into which contents can be located without requiring any direct operation by the user.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-007270, filed Jan. 16, 2009, which is hereby incorporated by reference herein in its entirety.

What is claimed is:

1. A layout apparatus comprising:
a deleting unit configured to delete at least one object from document data containing a plurality of objects disposed on a document;
a holding unit configured to hold the object deleted by the deleting unit;
an editing unit configured to edit the document data after the at least one object has been deleted by the deleting unit;
a first detection unit configured to detect whether an extra area in which the object held by the holding unit can be located is present in the document data edited by the editing unit;
a second detection unit configured to detect, among the objects held by the holding unit, any object that can be restored to the document data without increasing the number of sheets to be required to print the document data edited by the editing unit, when the presence of the extra area is detected by the first detection unit; and
a layout unit configured to restore the object detected by the second detection unit to the document data edited by the editing unit while maintaining a positional relationship between the object detected by the second detection unit and other objects that are not deleted by the deleting unit.

2. The layout apparatus according to claim 1, further comprising
a display control unit configured to control a display of a list of objects detected by the second detection unit.

3. The layout apparatus according to claim 1, wherein the holding unit is configured to hold, in a state where the object detected by the second detection unit is not yet deleted from the document data by the deleting unit, first identification information relating to an object that is positioned immediately before a layout position of the object detected by the second detection unit and second identification information relating to an object positioned immediately after the layout position of the object detected by the second detection unit, and wherein
the layout unit is configured to restore the object detected by the second detection unit to the document data edited by the editing unit based on the first and second identification information held by the holding unit while maintaining the positional relationship between the object detected by the second detection unit and the objects that are not deleted by the deleting unit.

4. The layout apparatus according to claim 1, further comprising a determination unit configured to determine, according to a deletion order of each object held by the holding unit, whether the object held by the holding unit can be restored to the document data without increasing the number of sheets to be required to print the document data edited by the editing unit.

5. A layout apparatus comprising:
a deleting unit configured to delete a first object from document data containing a plurality of objects disposed on a document and then delete a second object after the first object is deleted;
a holding unit configured to hold both the first and second objects deleted by the deleting unit; and
a layout unit configured to restore the first object held by the holding unit to the document data from which the first object and the second object have been deleted, while maintaining a positional relationship between the first object and other objects that are not deleted by the deleting unit, without restoring the second object, in response to an instruction to restore the first object to the document data from which the first object and the second object have been deleted without restoring the second object.

6. The layout apparatus according to claim 5, wherein the holding unit holds both identification information relating to an object disposed immediately before a position where the first object is disposed and identification information relating to an object disposed immediately after the position where the first object is disposed.

7. A layout method comprising:
deleting at least one object from document data containing a plurality of objects disposed on a document;
holding the deleted object;
editing the document data after the at least one object has been deleted;
determining whether an extra area in which the held object can be located is present in the edited document data;
detecting, among the held objects, any object that can be restored to the document data without increasing the number of sheets to be required to print the edited document data, when the presence of the extra area is detected; and
restoring the detected object to the edited document data while maintaining a positional relationship between the detected object and other objects that are not deleted.

8. A layout method comprising:
deleting a first object from document data containing a plurality of objects disposed on a document and then deleting a second object after the first object is deleted;
holding both the deleted first and second objects; and
restoring the first object to the document data from which the first object and the second object have been deleted, while maintaining a positional relationship between the first object and other objects that are not deleted, without restoring the second object, in response to an instruction to restore the first object to the document data from which the first object and the second object have been deleted without restoring the second object.

9. A computer-readable storage medium that stores a program to control a layout apparatus, wherein the program causes the layout apparatus to execute a method comprising:
deleting at least one object from document data containing a plurality of objects disposed on a document;
holding the deleted object;
editing the document data after the at least one object has been deleted;
determining whether an extra area in which the held object can be located is present in the edited document data;
detecting, among the held objects, any object that can be restored to the document data without increasing the number of sheets to be required to print the edited document data, when the presence of the extra area is confirmed; and
restoring the detected object to the edited document data while maintaining a positional relationship between the detected object and other objects that are not deleted.

10. A computer-readable storage medium that stores a program to control a layout apparatus, wherein the program causes the layout apparatus to execute a method comprising:
deleting a first object from document data containing a plurality of objects disposed on a document and then deleting a second object after the first object is deleted;
holding both the deleted first and second objects; and
restoring the first object to the document data from which the first object and the second object have been deleted, while maintaining a positional relationship between the first object and other objects that are not deleted, without restoring the second object, in response to an instruction to restore the first object to the document data from which the first object and the second object have been deleted without restoring the second object.
